(19) United States
(12) Patent Application Publication
(10) Pub. No.: US 2008/0123749 A1
(43) Pub. Date: May 29, 2008

(54) Method of transmitting at varying bit rates through a transmission channel

(76) Inventors: Pierre Bretillon, Meylan (FR); Antoine Pesme, Montigny les Metz France (FR)

Correspondence Address: CLARK & BRODY, 1090 VERMONT AVENUE, NW, SUITE 250, WASHINGTON, DC, 20005, US

(21) Appl. No.: 11/808,804

(22) Filed: Jun. 13, 2007

Related U.S. Application Data
(63) Continuation of application No. PCT/FR05/02868, filed on Nov. 18, 2005.

(30) Foreign Application Priority Data
Dec. 15, 2004 (FR) 0413321

(51) Int. Cl. H04N 7/28

(52) U.S. Cl. 375/240.22

(57) ABSTRACT

The invention relates to a method of transmitting an audio and/or video program via a transmission channel at adjustable bit rates, the method implementing an adjustment of at least one encoding and/or transmission parameter as a function of at least one setpoint vector having at least one dimension and representing a quality of reception desired by said end user.

Operators involved in distributing services, in particular video services, need to supply the end user with a given level of quality on the user's terminal in order to avoid devaluing the content of the service.

Operators must also minimize service storage costs and/or delivery costs by controlling both a method that is used for rate-reduction video encoding, and also the resources of the transmission network that are allocated to conveying the video service.

### FIELD OF THE INVENTION

Those encoding and transmission methods have an impact on the quality played back to the user, which impact varies, depending both on how the methods are configured and on the content of the video service.

Furthermore, the development of digital technologies has led to a very wide variety of terminals capable of playing back video images being made available to the public. Such terminals present a very wide variety of capabilities, for example going from the small screen of a portable terminal to the large screen of a TV set.

### BACKGROUND OF THE INVENTION

Numerous methods are known for allocating resources for rate-reduction encoding or digital transmission. The differences between those methods lies in the quality measurements used, the means for acting on quality (i.e. the resources on which the methods act), and sometimes also on the optimization algorithms implemented.

There are three main known types of quality measurement:
Physical measurements that give rise to information relating to individual unit information such as the bit error rate (BER) or the block error rate (BLER) in the transmission channel, the data rate of the channel, its passband, the power is conveys, the signal/interference ratio (SIR), etc. The bit error rate (BER below) is the measurement for characterizing channel errors that is in the most widespread use in the literature.
Measurements at network and transport level generally relate to information elements that are more structured, such as packets: packet loss rate, working data rate, transmission delay, variation in transmission delay.
Objective quality measurements are sometimes performed on the decoded image, however no use is made of such measurements for allocating resources. Measurements of video image complexity are also used in statistical multiplexing methods (see L. Böröczky, “Statistical multiplexing using MPEG-2 encoders”, IBM J. Res. Develop., Vol. 32, No. 4, July 1999) for the purpose of adjusting data rate.

Those measurements are used to control various mechanisms for acting on the encoded video stream:
at rate-reduction encoding level: the encoding rate, the number of layers when using a scalable encoder;
at the interface between the encoder and the network, and within the network: retransmission of a packet that has not been received or that has been received erroneously, modifying the level of data protection against errors by means of correction mechanisms, with data receiving greater or lesser amounts of protection depending on its importance, data transmission priorities, transmitter power.

Methods of allocating or optimizing resources are of two types:
Binary methods engaging an action or allocating a resource on the basis of an event detected by measurements. For example a packet is retransmitted over the network when a signal is sent by the receiver indicating that it is missing or erroneous.
Methods of controlling a resource from a relationship that has been previously determined in logical or empirical manner. An example of this approach is shown in the document 3GPP Technical Specification 23.107 V5.12.0 “Quality of Service (QoS) concept and architecture”, 3rd Generation Partnership Project: the transmission parameters of a service over a UMTS network are defined as a function of the type of service.

A particular field that uses techniques of adjusting resources is digital TV. At present, the adjustment of encoding rate takes no account of the characteristics of the various types of terminal that might be involved, and it is performed manually, at least in part:
Operators need to decide on the encoding rate for each program depending on its content, and possibly they need to adjust the data rate manually as a function of feedback from experience.

Alternatively, the use of variable rate-reduction encoding methods and of statistical multiplexing methods make it possible to obtain a rate that is variable as a function solely of the content of the video. Nevertheless, it is still necessary to set a minimum and a maximum acceptable data rate manually, said rates being selected as a function of the content of the program.

The operators involved in distributing video services need to provide the end user with a given level of quality, while minimizing the cost involved in storing and/or delivering the service, which involves adjusting how resources are used. As mentioned above, there thus exist techniques for allocating resources that are at least partially manual and techniques that are automatic. All of those known techniques present at least one drawback.

Many encoding resource adjustment techniques are presently manual, at least in part. For example, digital TV operators decide on the encoding rate for each program or each type of program and set their parameters manually. In practice, programs with a great deal of movement, such as sports programs, require a data rate that is greater than that required by other programs. Alternatively, the use of variable rate-reduction encoding methods and of statistical multiplexing methods makes it possible to obtain a rate that is variable as a function of the content of the video. Nevertheless, it is still necessary to act manually to set an acceptable minimum rate and an acceptable maximum rate. Furthermore, the quality criterion used for adjusting the encoding rate is a parameter derived from the complexity of the image and not a measurement of quality as perceived after encoding. Finally, that method does not take account of the characteristics specific to the terminal for the purpose of adjusting encoding parameters.

Existing techniques for automatically allocating transmission resources are all based on measuring transmission quality at network level. Unfortunately, that type of measurement is not very representative of the perceived quality as played back to the user. One result of using such non-perceptual measurements is that there is no guarantee about the quality played back to the end user, and consequently transmission resources are not used optimally. This means that an operator cannot guarantee a given level of perceived quality, and therefore cannot make use of transmission resources in optimum manner.

### OBJECTS AND SUMMARY OF THE INVENTION

The present invention provides a method and a system for selecting the configuration of rate-reduction video encoding and the allocation of resources at transmission network level.

The intended object is to play back a given level of video quality on a terminal and to optimize the use of storage and/or transmission resources. To do this, the method associates techniques for measuring the perceived video quality and possibly for optimization by vector quantizing, where appropriate.

The present invention proposes a method and a system for selecting the rate-reduction video encoding configuration and for allocating resources at transmission network level on the basis of the quality perceived at the terminal, and possibly also on the basis of the characteristics of the user's terminal.

The desired object is to play back a given level of video quality at the terminal and to optimize the use of storage and/or transmission resources.

To do this, the method associates techniques for measuring the perceived video quality and for performing optimization. The measurements of perceived quality can be obtained from decoded video images, instead of from the compressed video stream.

The invention thus provides a method of transmitting an audio and/or video program at varying bit rates over a transmission channel, the method implementing an adjustment of at least one encoding and/or transmission parameter as a function of at least one setpoint vector having at least one dimension representing a desired quality for reception by said end user.

A said transmission parameter may be the bit rate and/or the type of modulation and/or the transmission power.

Said adjustment is implemented from a deterministic relationship between the desired quality of reception and the encoding and/or transmission parameter(s).

Alternatively, said adjustment is implemented as a function of the distance between said setpoint vector and a measurement vector representing said reception quality as measured at said end user.

The quality of reception may be measured on a sequence of determined durations of said program. In particular, said adjustment is implemented by modifying the transmission power P as a function of a distance between the setpoint vector and the measurement vector.

In any event, said adjustment may be implemented as a function of at least one parameter concerning the content of the program. A content parameter may be an activity parameter and/or a parameter given to the name of the program and/or to the type of the program. Said adjustment may be also implemented as a function of a parameter characteristic of the terminal.

A parameter characteristic of the terminal may be the resolution of an image displayed on said terminal and/or its passband.

The method may generate a dictionary from a training set comprising NZ vectors R characterizing the data of NZ tests, each vector R_{Z} (Z varying 1 to NZ) of a test of rank z resulting from the union of a vector Q_{Z} representing the perceived quality of said test of rank z, a vector P_{Z} representing the encoding and/or terminal parameter(s) of said test of rank z, and optionally a vector T_{Z} representing the parameter(s) of the terminal of said test of rank z, and/or a vector C_{z} representing the content parameter(s) of said program.

In a first variant applicable when the number NZ is not very large, the dictionary is made up of the vectors of the training set. It is made up of a group of N vectors (N=NZ). The maximum number NZ of vectors for which this variant is applicable depends strongly on the characteristics of the application (e.g. the number of requests per second for a search for an optimum vector) and on implementation constraints (e.g. the computation capacity and the memory capacity that can be allocated to the process of searching for the optimum vector). For example, if it is desired to perform no more than 10,000 vector comparisons per second, it will then be possible to perform no more than 100 searches for optimum vectors per second in a list of NZ=100 vectors, or only 50 searches for optimum vectors per second in a list of NZ=200 vectors.

Otherwise, the dictionary is obtained from said training set by a vector classification algorithm, and is made up of a group of N vectors (with N<NZ) presenting minimum mean distortion relative to the NZ vectors of the training set. The number of vectors N of a dictionary to be used depends strongly on the characteristics of the application and on implementation constraints (as for the selection of NZ in the first variant), and is also a function of a compromise between the accuracy of the dictionary and its size. The larger the dictionary, the greater its accuracy, thereby giving the system better performance. In practice, a dictionary having N=20 to 40 vectors can be suitable for a training set comprising 10 different encoded sequences at two different resolutions and 10 different data rates (giving NZ=200 configurations).

After the dictionary has been built, the adjustment may be performed by vector quantization to determine the vector of the dictionary that corresponds best to a constraint vector representing at least the desired quality.

Said vector may be constituted by the union of a vector representing the desired quality and a vector representing at least one content parameter and/or a vector representing at least one parameter of the terminal.

In another variant, that does not make use of vector quantizing, but that involves measuring the quality perceived for the transmitted program at terminal level, a said adjustment, e.g. of the terminal power P, is implemented in steps of size DP as a function of the difference between the measured perceived quality Q and the target quality QC for the video program.

The method being:
if |Q−Q_{c}| is less than a first threshold, the power P is not modified;
if |Q−Q_{c}| lies between the first threshold and a second threshold, the power is increased or decreased by the step size DB depending on whether the sign of Q-QC is respectively negative or positive; and
if |Q−Q_{c}| lies between a second threshold and a first threshold greater than the second threshold, the power is increased or decreased by kDP with 1<k=2 depending on whether the sign of Q−Q_{c} is respectively negative or positive.

Advantageously, the method being the step size DP is variable as a function of the type of content associated with the video program.

### BRIEF DESCRIPTION OF THE DRAWINGS

Other characteristics and advantages of the invention appear on reading the following description with reference to the drawings, in which:

FIG. 1 shows the general context of supplying video services;

FIG. 2 shows a relationship between encoding rate and perceived quality, as a function of content;

FIG. 3 shows a saving in rate relative to FIG. 2;

FIG. 4 shows the method of the invention;

FIG. 5 shows encoding by vectorial quantization, while FIG. 6 shows the procedure of generating a dictionary;

FIG. 7 shows the procedure of generating a dictionary in the context of the present invention;

FIGS. 8 and 9 show sub-steps of searching for the encoding and transmission configuration with vector quantizing;

FIG. 10 shows the procedure of searching for the encoding and transmission configuration when using a deterministic relationship;

FIGS. 11 and 12 show the structure of a dictionary respectively without classification and with classification;

FIG. 13 shows selecting the optimum encoding rate as a function of the resolution of the terminal and of the requested quality;

FIG. 14 shows the sequencing of steps while adjusting to an optimum configuration;

FIG. 15 shows the adjustment of the transmission power as a function of the measured quality and the type of content; and

FIG. 16 shows an example of the impact of the loss of packets on the proportion of video images lost, as a function of the type of sequence (slow or fast).

The quality of a video service played back to the end user is clearly influenced by the method used for data rate reduction encoding, the resources allocated to the service in the transmission network, and the capacities of the display terminal.

### MORE DETAILED DESCRIPTION

FIG. 1 shows the main elements involved in providing a video service, i.e. video compression (or data rate reduction encoding), transmission to the terminal over the transmission network, and finally the terminal.

1) Methods of Video Compression or of Rate-Reduction Encoding:

They enable a binary information stream representing video images to be adapted to the capacities of equipment situated downstream: network equipment, terminal equipment. However these methods lead to losses of information: the images played back after decoding are not identical to the original images. This can lead to visible degradation of the images as decoded, thus having an impact on the quality of service delivered to the end user.

The extent to which a coding degradation is visible varies as a function of numerous parameters: the content of the video signal; the bit rate of the encoded binary stream; spatial resolution; the frequency with which images are refreshed, etc. In order to play back a desired level of quality, the parameters of the rate-reduction encoding method must therefore be selected with care.

2) Transmitting the Binary Stream Reduced by the Rate-Reduction Encoding to the Terminal Via a Transmission Network:

This transport may be accompanied by loss of binary information. Methods of receiving and then decoding the stream in a terminal then play back video signals that may suffer from visible degradation, thereby having an impact on the quality of service delivered to the end user.

The extent to which the degradation due to transmission is visible varies as a function of numerous parameters: content of the video signal, allocated bit rate or allocated transmission power, transmission protocol (by packet, with or without correction, . . . ), the distribution and the magnitude of losses, the type of information that is lost, etc. The invention proposes maintaining the level of quality delivered to the user while minimizing the use of network resources by adjusting transmission parameters to the requested quality or to the measured quality as compared with the requested quality.

3) The Terminal:

The characteristics of the binary stream and of the video need to be adapted to the processing and display capacities of the display terminal. For example, there is no point in sending a video stream at resolution greater than the resolution of the screen of the terminal, or that requires computation capacity exceeding that needed for receiving or decoding the stream. The characteristics of the terminal thus constitute constraints that need to be taken into account when selecting parameters for the video compression method.

By selecting parameters of the rate-reduction encoding method with respect to quality level in accordance with the invention, it is possible for the video service supplier to guarantee a perceived quality level. In addition, such selection taking account of the characteristic of the terminal enables the operator to minimize the resources needed for storage and/or transmitting the service.

Adjustment of the transmission parameters makes it possible to adapt to a change in the characteristics of the transmission channel in order to maintain perceived quality.

The invention makes it possible to obtain significant data rate savings. The quality perceived after rate-reduction encoding depends very greatly on the encoding rate. The type of content, and in particular the presence of movements and of fine details in the scene, requires a data rate that is greater than that required by a scene with little movement (said to be less complex) in order to obtain a given quality level.

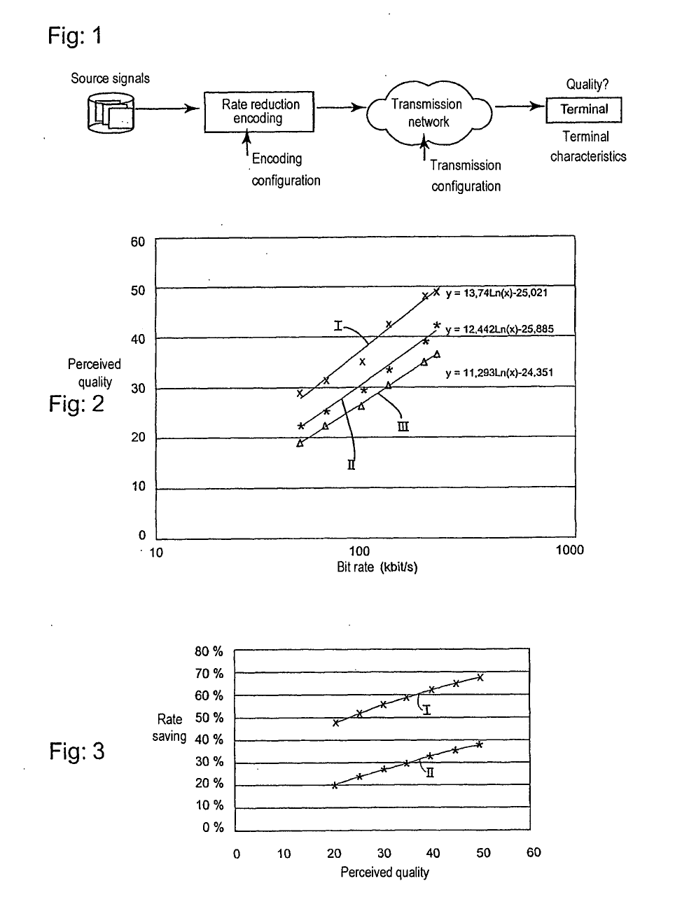

FIG. 2 shows the variation in perceived quality for three sequences I, II, and III of increasing complexity and as a function of encoding rate.

Without the proposed method of resource allocation that implements measuring perceived quality, there is no way of knowing the quality that is played back on the basis of measurements performed at network level, such as measurements of video stream rates or of binary error rate. One known solution for obtaining good quality is then to allocate the rate needed for guaranteeing the quality of the most complex sequence, and to use that allocation regardless of the particular sequence in question. Under such circumstances, FIG. 3 shows the savings in data rate compared with the sequence III in FIG. 2, thus showing a highly significant saving in data rate lying in the range 20% to 50%.

The sensitivity of a video stream transmitted over a digital network varies depending on the type of video content. The presence of movement has a large influence on the extent to which degradations generated by transmission errors are visible. With transmission over an Internet protocol (IP) network, it can be seen that for a given number of IP packets that are lost, the drop in quality is greater for video sequences having content with a large amount of movement.

Use can be made of this, in practice, in a method of adjusting the transmission power from a UMTS transmitter in order to give priority to video streams that are “complex”, i.e. that present a large amount of movement.

FIG. 4 shows an example of a system of the invention. It comprises essentially:
equipment 1 for measuring the perceived quality of a video signal in a broadcast or transport network. This equipment performs measurements on the basis of video signals decoded by the terminal. It may optionally be integrated in the terminal;
equipment 2 for optimizing encoding and/or transmission parameters P, on the basis of knowledge about the type of video content C, the characteristics of the terminal, the perceived quality QC that is to be obtained (or target quality), and the perceived quality C that is actually measured; and
the parameter optimization equipment is constituted by a database entity DB and by a decision entity RECH.

The methods of measuring the applicable video perception quality are those making use of the data coming from the video decoding process:
either solely the pixels of video images as received after transmission (the method is said to be with no reference);
or else the pixels of the video images received after transmission and a small proportion of source image information (the method is said to have a small amount of reference).

Reference can be made in particular to the patent applications filed by Télédiffusion de France and published under the numbers EP 1 020 085 and PCT WO 2004/047451, the PCT case being entitled “A method and a system for measuring the degradation to a video image that is introduced by rate-reduction encoding” for examples of these two types of method.

Methods of measuring quality with complete reference are not applicable since they require both the pixels of the video images received after transmission and the pixels of the images before transmission.

The purpose of the optimization procedure is to control the use of resources by seeking an encoding or transmission configuration that enables a given level of perceived quality to be reached. One or other of the following two techniques can be used:

1) using a database of representative instances of the relationship between perceived quality and the encoding or transmission network configuration. A search engine using vector quantization searches for the instance in the database that corresponds best to the desired perceived quality under the (unavoidable) present conditions while minimizing the resources requested of the network;

2) using a determined logical or empirical relationship to make a calculation in advance, giving the relationship between perceived quality and the encoding or transmission network configuration under consideration.

The optimization procedure can be performed by vector quantization.

Vector quantization is a technique that associates a point X (or vector) in t-dimensional space with the closest point Uₖ=QV(X) from amongst a set of N vectors U_{1 . . . N} known as a dictionary, where closeness is measured in terms of distance Δ.

U_{1 . . . N}=(Uj,j=1 . . . N) (1)

QV(X)=i/Δ(X,Uᵢ)≦Δ(X,Uₖ); k=1 . . . N (2)

Δ(X,U) being the distance between the vectors (X,U) (3)

That technique for modeling complex processes has been used by way of example with image encoding. The image is initially subdivided into subsets such as rectangular blocks of pixels, and then for each block of pixels, vector quantization consists in searching for the block of pixels in the dictionary (referred to as a vector) that is closest. Only an index or an address for the vector is transmitted to the image decoder, which decoder reconstitutes the image because it knows the dictionary and the corresponding vector identifiers.

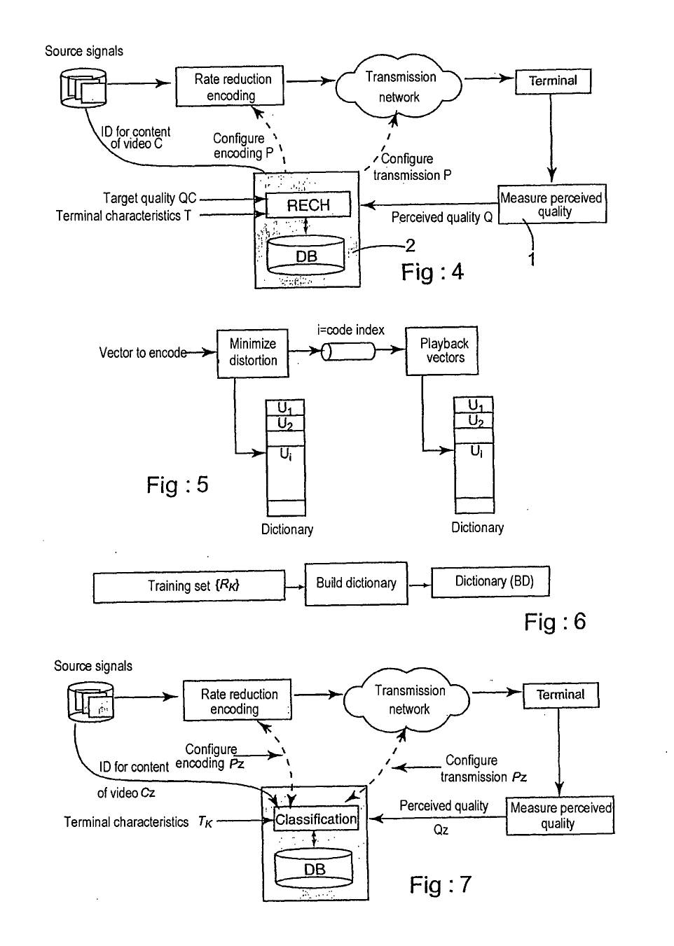

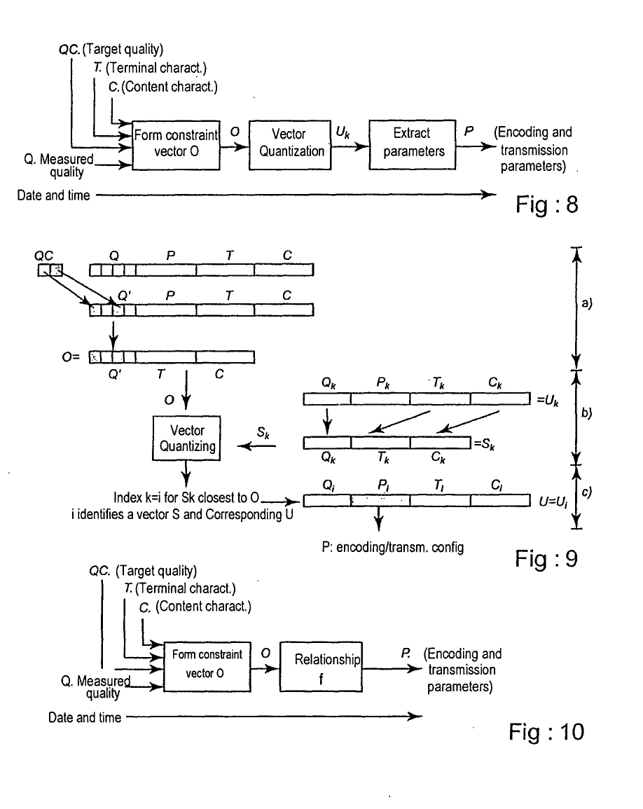

FIG. 5 shows the principle of encoding and decoding by vector quantizing. X is the vector to be encoded, Uₖ are the elements of the dictionary; with k=1 . . . N, and N being the number of vectors. Encoding by vector quantizing causes X to be made to correspond with the index (i) of its closest neighbor in the dictionary. This index is the code word that will be transmitted.

The concept of distance or distortion between two vectors is introduced in order to search the dictionary for the vector that is closest. Several distances have been proposed for optimizing vector quantization and for maximizing fidelity with the initial signals.

The distance or distortion known as quadratic error is one that is in the most widespread use for vector quantizing.

$$Δ ( A , B ) = \sqrt{{\sum }_{j = 1}^{t} {( {A}_{j} - {B}_{j} )}^{2}} \qquad ( 4 )$$

where (A,B) are two vectors of dimension t.

The use of the vector quantization technique relies on two main steps that are interdependent:

1) forming the dictionary on the basis of a training set; and

2) searching for the nearest neighbor using an appropriate distance.

The way in which those two steps are used in the invention for controlling the perceived quality of a video service encoded by rate reduction and transmitted digitally are described in succession below in this document.

Generating the dictionary DB constitutes a step that is prior to any optimization of the encoding and transmission configuration by vector quantization. The dictionary is a database DB containing representative instances Uₖ=U_{1 . . . N} of the relationship between perceived quality and the encoding or transmission network configuration for certain characteristics of the given video content and terminal.

In order to generate the dictionary, a set of tests needs to be performed. The data characterizing the tests consist in a training set {Rₖ} that is used by a specific procedure for dictionary construction (FIG. 6). This method is an empirical approach to modeling the relationship between perceived quality and the encoding or transmission network configuration by performing training for certain characteristics of a particular video content and terminal.

Each of the NZ tests is identified by its number z. Each test gives a particular instance of the relationship between the measured perceived quality Q_{z} and the encoding and transmission parameters P_{z} for the characteristics of the given terminal T_{z} and video content C_{z}. Appropriately selecting the various tests performed makes it possible to reach a dictionary that presents high performance.

For this purpose, in order to enable the relationship between the various parameters to be modeled well, the parameters P_{z}, T_{z}, and C_{z} are caused to vary, firstly over a range corresponding to operating conditions in practice, and secondly in such a manner as to obtain the desired perceived quality levels Q_{z} (FIG. 7).

Q_{z}, P_{z}, T_{z}, and C_{z} are vectors in the most general case:

Q_{z}=(VQ_{1,z}, . . . , VQ_{nq,z}) (5)

with nq=number of quality parameters, and

### VQ_{1 . . . nq,z}=quality parameters for test z.

P_{z}=(VP_{1,z, . . . ,} VP_{np,z}) (6)

with np=number of encoding and transmission parameters, and

### VP_{1 . . . np,z}=encoding and transmission parameters for test z.

T_{z}=(VT_{1,z, . . . ,} VT_{nt,z}) (7)

with nt=number of terminal parameters, and

### VT_{1 . . . nt,z}=terminal parameters for test z.

C_{z}(VC_{1,z, . . . ,} VC_{nc,z}) (8)

with nc=number of content parameters, and

### VC_{1 . . . nc,z}=content parameters for test z.

Each training vector R_{z} of dimension t comes form the union of Q_{z}, P_{z}, T_{z}, and C_{z}. It characterizes the data set associated with test z (perceived quality, encoding and transmission parameters, terminal parameters, and content parameters):

R_{z}=Q_{z}∪P_{z}∪T_{z}∪C_{z}=(V_{1,z, . . . ,} V_{t,z}) (9)

with t=ng+np+nt+nc

∪=union

TABLE 1
Data constituting the training set

| Rz | z | Qz | Pz | Tz | Cz |
|---|---|---|---|---|---|
| R₁ = | 1 | VQ_{1,1}; . . . VQ_{nq,1} | VP_{1,1}; . . . VP_{np,1} | VT_{1,1}; . . . VT_{nt,1} | VC_{1,1}; . . . VC_{nc,1} |
| R₂ = | 2 | VQ_{1,2}; . . . VQ_{nq,2} | VP_{1,2}; . . . VP_{np,2} | VT_{1,2}; . . . VT_{nt,2} | VC_{1,2}; . . . VC_{nc,2} |
| . . . | . . . | . . . | . . . | . . . | . . . |
| R_{NZ} = | NZ | VQ_{1,NZ}; . . . VQ_{nq,NZ} | VP_{1,NZ}; . . . VP_{np,NZ} | VT_{1,NZ}; . . . VT_{nt,NZ} | VC_{I,NZ}; . . . VC_{nc,NZ} |

The set of vectors R_{z}, 1<z≦NZ constitutes the training set (Table 1). A specific procedure is applied to the training set in order to generate the dictionary of representative instances Uₖ with 1<k≦N. Two situations are possible:
Situation 1 (corresponding to the first variant without vector classification): the number of combinations between quality levels, encoding and transmission configurations, and terminal content characteristics is limited (e.g. NZ<100). In this situation, the dictionary U_{1 . . . N} can merely be equal to the training set:

U_{1 . . . N}=(Rₖ,k=1 . . . NZ) and N=NZ (10)

The limit of the number of combinations can be set freely, e.g. using implementation criteria such as the size of the database or the computation file needed by the optimization model in order to find the optimum configuration.
Situation 2 (corresponding to the second variant with vector classification): the number NZ of combinations R_{z} contained in the training set is very large. An analysis procedure is needed in order to generate the N vectors U_{1 . . . N} of the dictionary that best represent the initial vector set R_{z}. This group of vectors is the group that presents the smallest mean distortion relative to all of the vectors of the training set, amongst all other potential candidate dictionaries. The vectors of this group are then the best vectors for representing the training set, and consequently the relationship between quality and encoding and transmission configuration and terminal and content characteristics.

Classification algorithms are used. Several authors have proposed solutions for classifying dictionaries: dynamic clouds, or the LBG algorithm. The number N of vectors of the dictionary is selected depending on the initial number of vectors in the training set, the precision of the modeling, and implementation constraints.

The dictionary obtained by the classification procedure constitutes the database DB (FIG. 7).

Naturally, it is possible at the least to make use of a training vector that takes account only of perceived quality and the encoding and transmission parameter. Nevertheless, it is advantageous to take account of content. The parameters of the terminal do not need to be taken into account except when the users of an intended application are diverse and when it is possible to obtain the parameter for the terminal of a given user.

The following step consists in searching for the encoding and transmission configuration.

The first step has generated a dictionary that is representative of the relationship between the measured perceived quality and the encoding and transmission network configuration for certain characteristics of the given video content and terminal.

The second step makes use of the dictionary to find an encoding and transmission configuration that guarantees a certain target quality QC for the end user. To do this, the module RECH searches for said configuration in the database DB (FIG. 4).

The data represented by FIG. 4 is defined below:
The vector Q contains the current measured perceived quality parameters. It is identical to the vector defined by equation (5).

Q=(VQ₁, . . . , VQ_{nq}) (11)

where nq=the number of quality parameters VQᵢ

A time and date stamp representative of the time the video content is presented is also associated with this vector Q.

### E.g. nq=1, Q=quality index in the range 0 to 100.

The vector QC defines the target perceived quality parameters to be achieved. All of the parameters VQCᵢ of QC characterizing the target quality exist in Q, but may naturally have different values. Conversely, all of the parameters VQᵢ of Q characterizing the measured quality do not necessarily exist in QC.

For example, the vector QC may be of dimension nqc=1 and may contain a single value gqc corresponding to the target quality to be achieved (e.g. the target quality purchased by the user by contract with the supplier of an audiovisual service) for the quality of the audiovisual service (gqc).

The vector Q must necessarily contain an audiovisual quality value gq obtained by measurement to enable the method of optimization by vector quantization to operate, by comparing gq with gqc. Q may be of dimension greater than the dimension nqc of QC, for example nqc=1, but nq=3 in the configuration where Q contains three values Q=(aq, vq, gq) corresponding respectively to the quality obtained by measuring the audio (aq), the video (vq), and the audiovisual (gq) signals.

QC=(VQC_{1, . . . ,} VQC_{nqc}) (12)
where nqc<nq and nqc=the number of target quality parameters VQCᵢ

For example nqc=1, QC=target quality index in the range 30 to 95.
The vector T contains the parameters that are characteristic of the terminal. It is identical to the vector defined by equation (7).

T=(VT_{1, . . . ,} VTₙₜ) (13)
where nt=number of characteristic parameters of the terminal VTᵢ

For example nt=1, parameter VT1=screen resolution.
The vector C defines the parameters of the video content. It is identical to the vector defined by equation (8).

C=(VC_{1, . . . ,} VC_{nc}) (14)
where nc=the number of parameters of the video content VCᵢ

For example nc=1, parameter VC₁=activity of a video sequence or the type of the sequence (slow, fast, medium).
The vector P defines the looked-for encoding and transmission parameters. It is identical to the vector defined by equation (6).

P=VP_{1, . . . ,} VPₙₚ) (15)
where np=number of encoding and transmission parameters VPᵢ

For example, np=1, 2, or 3, VP₁, VP₂, VP₃=transmission power and/or bit rate and/or passband.

The process for searching for the optimum configuration for encoding and transmission consists in extracting the vector P that gives the encoding and transmission configuration to be used so as to deliver the quality of service to the user as defined by the vector QC representative of the target quality under the current conditions of constraints represented by the values Q, T, and C. The advantage of the vectorization method is that there is no need to measure the perceived quality Q other than while building the dictionary.

The search process is subdivided into three sub-steps:

a) forming a constraint vector O. The date and time associated with the vector Q is associated with the constraint vector O. This date and time is representative the time at which the video content is presented;

b) vector quantizing on the constraint vector O to find the vector Uₖ of the dictionary that corresponds best to the constraint vector O presented at the input; and

c) extracting the vector P of parameters for the encoding and transmission system.

Sub-Step a) Forming the Constraint Vector O

The vector O representing the current set of operating constraints on the system is constituted in the highest performance circumstance of the union of the vectors T and C and a combination Q′ of the vectors Q and QC. Each parameter of the vector O must be unique, while the parameters of the parameter QC are all present in the vector Q. The final objective is to find the encoding parameter vectors P that enable a target quality as defined by QC to be obtained.

Q′=QC ∪{VQᵢ such that VQᵢ does not exist in QC}with VQᵢ defined by Q=(VQ_{1, . . . ,} VQ_{nq}) (16)

For example, when QC is of dimension nqc=1 and contains a single vector gqc corresponding to the target quality to be achieved, and Q is of dimension nq=3 and contains three vectors Q=(aq, vq, gq) corresponding respectively to the signal at the measured audio (aq), video (vq), and audiovisual (gq) qualities, the vector Q′ resulting from applying equation (16) is Q′=(gqc), corresponding to the constraint of the audiovisual quality to be obtained by the encoding and transmission system.

The vector O is then formed by the union of T, C, Q′. The resulting vector is of dimension h:

O=Q′∪T∪C=(VO_{1, . . . ,} VOₕ) (17)

where h=nq+nt=nc

Sub-Step b) Vector Quantizing

Vector quantizing causes the input vector O of parameters VOᵢ to correspond with the dictionary vector U that is the closest to the constraint vector O presented at the input. Vector quantizing proper is performed on a sub-vector Sₖ of each vector Uₖ. The vector O contains only a subset of the parameters of the vectors Uₖ. The parameters of Uₖ that are not present in O are the encoding and transmission parameters Pₖ associated with said set of constraints O. Each vector Sₖ is thus defined by:

Sₖ={Vᵢ·such that Vᵢ does not exist in 0}with Vᵢ defined by U=(V₁, . . . , Vᵢ) (18)

Minimizing the distortion between the incident vector O and all the sub-vectors Sₖ of the vectors U_{1 . . . N} of the dictionary is then performed. It serves to identify the vector U that corresponds best with the constraint vector O.

Sub-Step c) Extracting Encoding and Transmission Parameters

The parameters of U that are not present in O are the encoding and transmission parameters P associated with said set of constraints O. It therefore suffices to extract from U the vector P that represents the encoded parameters and that is thus defined by:

P={Vᵢ such that Vᵢ does not exist in 0}with Vᵢ defined by U=(V₁, . . . , Vₜ) (19)

The entire operation of the search procedure is shown in FIG. 9 for the specific circumstance of nq=4 and nqc=2.

Once the parameters of the vector P have been found, together with certain parameters of the vector U found by vector quantizing in sub-step b), if necessary, it is then possible to apply them to the rate reproduction encoding process and to the transmission process.

Some parameters considered as constraint parameters, and thus present in the vector O, can also be parameters that are useful for defining the transmission configuration.

For example, we consider the situation in which it is desired to optimize the video encoding configuration by acting on two parameters, namely spatial resolution and encoding rate. If there are two different types of terminal, corresponding to two possible spatial resolutions for the screen, and if those terminals are not capable of displaying correctly video that is encoded at a resolution other than the resolution of their own screens, then the resolution parameter becomes a constraint for the method of encoding the video with rate reduction. The only parameter of the vector P is then the encoding rate. Nevertheless, the encoding resolution (as imposed by the terminal) must also be applied to the encoding method in order to ensure that the optimization method is exhaustive.

The database DB also has a function of storing data generated by the module for measuring perceived quality, together with optimization decisions taken by the module RECH. For this purpose, the database DB stores the vectors O and Pᵢ shown in FIG. 9, together with the date and time representing the time the video content is presented, which date and time is associated with the vector O.

An alternative to vector quantizing is to perform calculation by implementing a relationship that is logically or empirically determined in advance, giving the relationship between perceived quality and the encoding or transmission network configuration under consideration. The optimization procedure f gives the encoding and transmission parameters P that are to be used to obtain a target quality QC, given the characteristics of the terminal T and of the video content C, and given the presently measured quality level Q (FIG. 10). The variables P, QC, T, C, and Q are defined by equations (11) to (15), pages 18 and 19.

P=f(QC,Q,T,C) (20)

Under these circumstances, all of the knowledge needed for the optimization procedure is thus contained in the deterministic relationship, located in the module RECH. The database DB does not contain data relating to the optimization procedure.

The optimization approach using a deterministic relationship is advantageous since it does not require a database, which might be very large. In contrast, a deterministic relationship can be determined easily only when the number of configurations is small.

The approach using vector quantizing and a database of representative instances is more advantageous when there are numerous configurations.

The invention applies particularly well to providing video sequences on demand from a server by having recourse to vector quantizing the encoding rate that is optimal as a function of the resolution of the terminal and the quality requested by the end user, as a function of the type of sequence desired.

This application makes use of the invention to select the data rate for pre-encoded video sequences stored on a video server from amongst a certain number of possible values. The resolution of the user terminal and the desired quality level are taken into account so as to minimize the data rate needed for supplying the service, thus leading to optimum utilization of the transmission network. The transmission network used may, for example, be of one of the following types: Internet protocol (IP); digital video broadcasting (DVB); or universal mobile telecommunications system (UMTS).

The application can use an optimization procedure based on vector quantization, as described above.

Using the same notation, this application thus defines the parameters Q, QC, T, P, and C as follows:
Q=QC=measured or target video quality lying in the range 0 to 100. The method for measuring quality includes, for example, the method according to above-mentioned PCT patent application WO 2004/047451 filed by TDF;
T=terminal screen resolution, i.e. CIF (352×288) or QCIF (176×144);
P=encoding data rate in kbit/s; and
C=name of the sequence,
   or in a second variant;
C=type of content (sport, news, . . . ) n order to characterize the video content by sequence type.

Otherwise, it is possible to characterize the video content by a parameter for the activity of the image in one or more sub-sequences of a few seconds in a sequence.

Two variant ways of building the dictionary are described below, depending on whether the video content is defined by content name or by the type of content in the dictionary contained in the DB module.

The first variant makes use of content name and is described with reference to FIG. 11.

1) Some number of source video signals are required and encoded by rate reduction. The encoding is performed using all possible terminal resolutions, and using a plurality of data rates selected from a range corresponding to the capabilities of the terminals and of the transmission network. In the present example, the CIF and QCIF resolutions are used, with transmission channel data rates lying in the range 48 kbit/s to 384 kbit/s, for example, with a step size of 10 kbit/s, being applied for each of those two resolutions.

2) Each stream is evaluated by the perceived quality measurement module. The quality Q_{z} characterizing the encoded video sequence is the mean quality measured over the sequence.

3) The encoded video streams are stored on a video server. The other data constituting the dictionary stored in DB includes the quality Q, the data rate P of the transmission channel, the resolution T of the terminal, and the content name C. It is therefore not necessary in this example to use a classification procedure since the size of the dictionary remains modest.

The dictionary can then be used by the module RECH to find the data rate needed, as explained above.

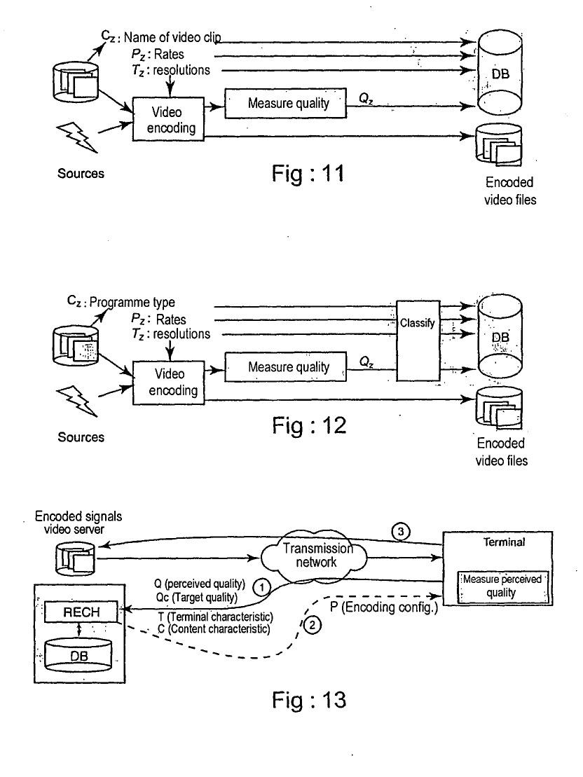

A second variant using content size instead of content name is described below with reference to FIG. 12. The dictionary is built in similar manner: the sequences are encoded in all desired configurations and their qualities Q_{z} are evaluated. The difference lies in using information about content type (e.g. sports or news) instead of name. The impact of rate reduction video encoding on perceived quality varies greatly as a function of the type of content in a sequence, in particular by the presence of additional defects introduced by the transmission channel. For example, sports sequences generally require a higher rate because their content has more movement. It is possible to use this property to make a type of content correspond to the encoding rate needed for obtaining given quality on reception.

To do this, a classification procedure is preferable so as to group together the various quality measurements Q_{z} carried out under the same viewing and encoding conditions T_{z} and P_{z} for a plurality of sequences that are different, but all of the same type C_{z}, with this being stored in a single vector Q, T, P, C. In this embodiment, the classification procedure used is preferably the LBG algorithm with distance as presented below in equation (21).

FIG. 13 shows details of how the optimization procedure is implemented when a request is submitted by a user.

Initially, the user accesses a list of content stored on a video server, the content being identified by name and type, e.g. by means of an Internet browser; the user selects a content and a desired level of quality and makes a request. Thereafter, the mechanism using the invention takes place in three stages without intervention by the user:

1) The user terminal sends to the module RECH its own characteristics, the characteristics of the selected content, the desired quality level QC, and possibly the most recent quality measurement Q.

2) The module RECH searches by means of vector quantization in the database for the encoding rate P that exists for the content C on the video server that will ensure the requested quality QC, at the resolution imposed by the terminal, and it sends this information to the terminal. The parameters as received and then sent to the terminal are also stored in the database, e.g. for subsequent analysis.

The user terminal accesses the content C selected by the user at the rate P selected by RECH, and the user obtains the requested content with quality QC.

It should be observed that the linear distance between two vectors A and B that may be used herein for vector quantization is simpler to implement than is the quadratic distance of equation (4).

$$Δ ( A , B ) = {\sum }_{j = 1}^{t} \vert {A}_{j} - {B}_{j} \vert \qquad ( 21 )$$

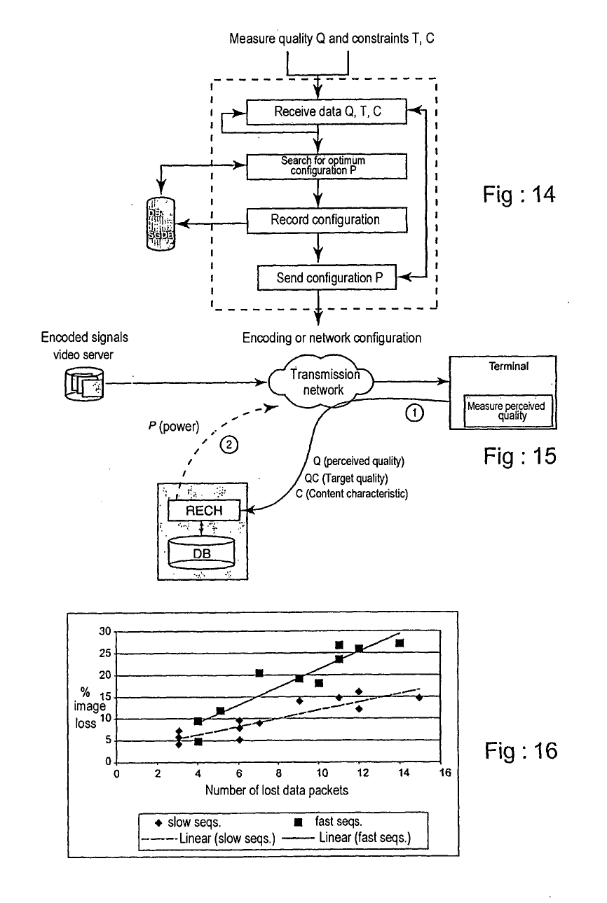

FIG. 14 shows the sequencing of the operations performed by the module RECH.

RECH receives the characteristics of the terminal T and of the content C, and possibly also the quality measurements Q. It stores these measurements in the database DB via a database management system (DBMS). Thereafter RECH performs a search for the best encoding or transmission configuration P on the basis of the dictionary also stored in DB. The configuration P is sent to the equipment concerned.

In a variant of this first application in which the optimum encoding rate is selected as a function of the resolution of the terminal and of the requested quality, the method of the invention is used to minimize the rate at which video sequences are encoded while taking account solely of the quality level that is to be reached, this leading to optimum utilization of the transmission network. This approach is particularly applicable when the utilization conditions of the video service, and in particular the type of terminal, and the type of service content, vary little. This applies for example with an on-request video service for viewing on television type terminals by users.

The invention uses the same optimization procedure based on vector quantization, as described above for said first application, and with the same notation. The main difference is that the parameters T and P are empty. Vector quantization is then based on:
Q=QC=measured or target video quality lying in the range 0 to 100. The quality measurement method makes use for example of the method according to above-mentioned PCT application WO/2004/047451;
P=encoding data rate in kbit/s.

The same methods can be used for building the dictionary and for optimizing the parameters P, in this case restricted to encoding rate.

In another variant, the method of the invention can be used for example to adjust the transmission power as a function of desired quality and possibly also as a function of the type of content, without implementing vector quantizing.

This application adjusts the transmission power level of the service from a transmitter of the UMTS access network as a function of perceived quality instead of as a function of standard network level parameters as used in UMTS, such as the signal-to-noise ratio Eb/No. The idea is to maintain a given quality level and not a target binary error rate.

The sensitivity of a video stream transmitted over a digital network varies depending on the type of video content. The presence of movement has a large influence on the extent to which degradation caused by transmission errors is visible. In the proposed implementation, the invention takes advantage of this property to react only when that is needed in order to maintain the perceived quality.

Under such circumstances, the invention can make use of an optimization procedure based on a deterministic algorithm, as described above. There is then no training procedure leading to a dictionary. Using the same notation as above, this application defines the parameters Q, QC, T, P, and C as follows:
QC=target video quality lying in the range 0 to 100;
Q=measured or target video quality lying in the range 0 to 100. The method of measuring perceived quality includes the method of above-mentioned PCT patent application WO 2004/047451. Q also includes other measurements: the actual data rate received by the terminal, and the rate at which packets of erroneous data are received;
   T=(not used);
   P=transmission power (in dB);
C=not used,
   or in a second variant:
C=content type (sport, news, . . . ).

FIG. 13 shows a preferred implementation of this application.

The user accesses a list of content stored on a video server, e.g. by using an Internet navigator, the content being identified by name and by type; the user selects a content and a desired quality level. Thereafter, the mechanism using the invention takes place in three stages without intervention by the user:

1) The terminal sends periodically to the module RECH the most recent quality measurement Q, the desired quality level QC, and in the second variant, the characteristics C of the selected content.

2) The module RECH applies the optimization procedure on the basis of C, QC, and Q in order to discover the power P needed for ensuring the requested quality QC under the conditions of quality as presently perceived for the content C. This power P is applied to the video service transmission network.

The parameters received from the terminal and then sent to the network are also stored in the database, e.g. for subsequent analysis.

This optimization procedure that does not make use of vector quantization acts on power as a function of measured perceived quality Q. The greater the departure of the measured quality Q from the target quality QC, the greater the amount of variation in the power.

The procedure periodically calculates the new power P, e.g. once every second, on the basis of the current power Pold. This can be summarized as follows:

A step size DP for increasing the power is defined.

### If |Q−QC|<5 P=Pold

### If 5<|Q−QC|<10 P=Pold−sign(Q−QC)×1×DP

### If 10<|Q−QC|<20 P=Pold−sign(Q−QC)×2×DP

### Else P=Pold−sign(Q−QC)×4×DP

The function sign(X) returns the sign of X. Thus, power is increased when Q<QC. For example DP may represent 1% to 5% of the power.

The method can also be implemented to take account simultaneously of the quality measured at the terminal and the type of content, without having to vector quantizing.

This variant takes advantage of the variation in sensitivity of a video stream to transmission errors depending on the type of video content. When transmitting over an IP or a UMTS network, it is found that for a given number of IP packets that are lost, the drop in quality is greater for video sequences having content with a large amount of movement. FIG. 16 shows this phenomenon by taking as the degradation criterion the proportion of video images lost in transmission: the loss of images is greater for sequences that have a great deal of movement, which corresponds to quality that is less good.

This second variant of the optimization procedure takes advantage of this property by using the following procedure:

Two step sizes for increasing power are defined, one for each type of content: DP_sport>DP_news.

If C=sport, DP=DP_sport, e.g. 2% to 10% of the power. Else DP=DP_news, e.g. 1% to 5% of the power.

### If |Q−QC|<5 P=Pold

### If |Q−QC|<10 P=Pold (sign(Q−QC)×1×DP

### If |Q−QC|<20 P=Pold−sign(Q−QC)×2×DP

### Else P=Pold−sign(Q−QC)×4×DP

The function sign(X) returns the sign of X. Thus, power is increased when Q<QC.

### EXAMPLES

### Example 1

For the first variant of the first application (selecting the optimum encoding rate as a function of the resolution of the terminal and the requested quality, using content name).

The table shows a real example of a portion of a dictionary used for searching for the optimum rate at a function of a target quality and of a content designated by its name, with a display resolution constraint. The extract shown is valid for five different contents encoded in a combination of two resolutions and four rates. These contents have the following names: football, kayak, wood, TV news, and cartoon.

TABLE 1
Example extracted from the dictionary
(variant 1)

| Image size | Bit rate | | |
|---|---|---|---|
| (in pixels) | (kbit/s) | Sequence name | pqos |
| 352 288 | 64 | Football | 8.6 |
| 352 288 | 64 | Kayak | 8.9 |
| 176 144 | 64 | Football | 12.1 |
| 352 288 | 64 | Wood | 12.3 |
| 176 144 | 64 | Kayak | 12.7 |
| 352 288 | 128 | Kayak | 13.9 |
| 352 288 | 64 | TV news | 14.4 |
| 352 288 | 128 | Football | 16.4 |
| 176 144 | 128 | Football | 19.4 |
| 352 288 | 128 | Wood | 20.6 |
| 176 144 | 128 | Kayak | 22 |
| 352 288 | 64 | Cartoon | 22.4 |
| 176 144 | 64 | Wood | 22.7 |
| 352 288 | 384 | Football | 28 |
| 352 288 | 384 | Kayak | 31.1 |
| 352 288 | 128 | TV news | 32.1 |
| 352 288 | 128 | Cartoon | 32.4 |
| 176 144 | 64 | TV news | 32.8 |
| 176 144 | 64 | Cartoon | 33.7 |
| 176 144 | 128 | Wood | 39.1 |
| 176 144 | 128 | TV news | 39.6 |
| 176 144 | 384 | Kayak | 42.1 |
| 352 288 | 384 | Wood | 43.7 |
| 352 288 | 1024 | Football | 45.1 |
| 352 288 | 1024 | Kayak | 48.1 |
| 176 144 | 384 | Football | 53.1 |
| 352 288 | 384 | TV news | 53.1 |
| 176 144 | 128 | Cartoon | 55.6 |
| 176 144 | 384 | Wood | 57.9 |
| 352 288 | 384 | Cartoon | 59.6 |
| 176 144 | 1024 | Football | 61 |
| 352 288 | 1024 | Wood | 62.2 |
| 176 144 | 384 | TV news | 63.7 |
| 352 288 | 1024 | TV news | 63.8 |
| 176 144 | 1024 | Kayak | 65.7 |
| 352 288 | 1024 | Cartoon | 66 |
| 176 144 | 1024 | Cartoon | 66.8 |
| 176 144 | 1024 | Wood | 66.9 |
| 176 144 | 384 | Cartoon | 68 |
| 176 144 | 1024 | TV news | 75.7 |

The coordinates of each line in Table 1, i.e. of each vector of the dictionary, can be associated with the definitions of the vectors Q, C, T, and P defined above for equations (5), (6), (7), and (8), as follows:

Q=(pqos) and nq=1

pqos=sequence quality in the range 1 to 100

C=(sequence name) and nc=1

T=(image size) and nt=1

P=(bit rate) and np=1

The application of the vector quantization procedure with a QC vector containing a target quality value of pqos then makes it possible to select the optimum value for the “bit rate” parameter. In this example, the distance between two “image size” coordinates (or “bit rate”) is zero if the two coordinates of a given vector are equal, otherwise it can be selected for example as being equal to 100 so as to have an order of magnitude comparable to the pqos coordinate.

Then, as mentioned above in the description (sub-step c), the encoding configuration sent to the encoder is made up of the vector P possibly together with said elements of the vector U. In the present example, the parameters “image size” or “bit rate” constitute this configuration.

### Example 2

For the second variant of the first application (selecting the optimum encoding rate as a function of the resolution of the terminal and of the requested quality, while using content type).

The table gives a real example of a dictionary used for searching for the optimum rate as a function of a target quality and of a content type (news or sport) with a display resolution constraint.

TABLE 2
Example of dictionary (variant 2)

| | Bit rate | Content | |
|---|---|---|---|
| Image size | (kbit/s) | type | pqos |
| 352 288 | 64 | News | 16.1571429 |
| 176 144 | 64 | News | 26.1714286 |
| 352 288 | 128 | News | 26.0714286 |
| 176 144 | 128 | News | 39.4857143 |
| 352 288 | 384 | News | 47.4142857 |
| 176 144 | 384 | News | 57.6857143 |
| 352 288 | 1024 | News | 62.5 |
| 176 144 | 1024 | News | 64.9428571 |
| 352 288 | 64 | Sport | 10.1 |
| 176 144 | 64 | Sport | 12.4 |
| 352 288 | 128 | Sport | 15.9666667 |
| 176 144 | 128 | Sport | 20.7 |
| 352 288 | 384 | Sport | 32.8666667 |
| 176 144 | 384 | Sport | 47.6 |
| 352 288 | 1024 | Sport | 50.9333333 |
| 176 144 | 1024 | Sport | 63.35 |

The coordinates of each line of Table 2, i.e. of each vector of the dictionary, can be associated with the definitions of the vectors Q, C, T, and P as defined above in equations (5), (6), (7), and (8), as follows:

Q=(pqos) and nq=1

C=(content type) and nc=1

T=(image size) and nt=1

P=(bit rate) and np=1

Applying the vector quantizing procedure with a vector QC containing a target quality value of pqos then enables the optimum value to be selected for the “bit rate” parameter. In the present example, the distance between two image size or bit rate coordinates is zero if the two coordinates are equal, otherwise it can be selected to be equal to 100, for example, in order to present an order of magnitude comparable to the pqos coordinate.

Thereafter, as mentioned above in the description (sub-step c), the encoding configuration sent to the encoder is made up of the vector P possibly together with some of the elements of the vector U. In the present example, the “bit rate” and “image size” parameters constitute this configuration.

What is claimed is:

1. A method of transmitting an audio and/or video program at varying bit rates over a transmission channel, the method implementing an adjustment of at least one encoding and/or transmission parameter as a function of at least one setpoint vector having at least one dimension representing a desired quality for reception by said end user.

2. A method according to claim 1, the method being implemented for delivering video sequences to a user from a server, and implementing the user's choice of a video sequence and of a chosen quality level QC.

3. A method according to claim 1, wherein a said transmission parameter is the bit rate and/or the type of modulation and/or the transmission power.

4. A method according to claim 1, wherein said adjustment is implemented from a deterministic relationship between the desired quality of reception and the encoding and/or transmission parameter(s).

5. A method according to claim 1, wherein said adjustment is implemented as a function of the distance between said setpoint vector and a measurement vector representing said reception quality as measured at said end user.

6. A method according to claim 5, wherein the quality of reception is measured on a sequence of determined durations of said program.

7. A method according to claim 5, wherein said adjustment is implemented by modifying the transmission power P as a function of a distance between the setpoint vector and the measurement vector.

8. A method according to claim 1, wherein said adjustment is also implemented as a function of at least one parameter concerning the content of the program.

9. A method according to claim 1, wherein a content parameter is an activity parameter and/or a parameter given to the name of the program and/or to the type of the program.

10. A method according to claim 1, wherein said adjustment is also implemented as a function of a parameter characteristic of the terminal.

11. A method according to claim 10, wherein a parameter characteristic of the terminal is the resolution of an image displayed on said terminal and/or its passband.

12. A method according claim 1, the method implementing generating a dictionary from a training set comprising NZ vectors R characterizing the data of NZ tests, each vector R_{Z} of a test of rank z resulting from the union of a vector Q_{Z} representing the perceived quality of said test of rank z, a vector P_{Z} representing the encoding and/or terminal parameter(s) of said test of rank z, and optionally a vector T_{Z} representing the parameter(s) of the terminal of said test of rank z, and/or a vector C_{z} representing the content parameter(s).

13. A method according to claim 12, wherein the dictionary is made up of the vectors of the training set.

14. A method according to claim 12, wherein the dictionary is obtained by a vector classification algorithm from said training set, and is made up of a group of N vectors presenting minimum mean distortion relative to the NZ vectors of the training set.

15. A method according to claim 13, wherein the adjustment is performed by vector quantization to determine the vector of the dictionary that corresponds best to a constraint vector representing at least the desired quality.

16. A method according to claim 15, wherein the constraint vector is constituted by the union of a vector representing the desired quality and a vector representing at least one content parameter and/or a vector representing at least one parameter of the terminal.

17. A method according to claim 1, wherein a said adjustment, e.g. of the terminal power P, is implemented in steps of size DP as a function of the difference between the measured perceived quality Q and the target quality QC for the video program.

18. A method according to claim 17, wherein:
if |Q−Q_{c}| is less than a first threshold, the power P is not modified;
if |Q−Q_{c}| lies between the first threshold and a second threshold, the power is increased or decreased by the step size DB depending on whether the sign of Q−QC is respectively negative or positive; and
if |Q−Q_{c}| lies between a second threshold and a first threshold greater than the second threshold, the power is increased or decreased by kDP with 1<k=2 depending on whether the sign of Q−Q_{c} is respectively negative or positive.

19. A method according to claim 18, wherein the step size DP is variable as a function of the type of content associated with the video program.
